(19) United States
(12) Patent Application Publication
(10) Pub. No.: US 2015/0191258 A1
(43) Pub. Date: Jul. 9, 2015

(54) ACCESS TUNNEL TO AN AIRCRAFT

(71) Applicant: Hübner GmbH & Co. KG, Kassel (DE)

(72) Inventors: Detlef Gutkuhn, Espenau (DE); Lothar Scharf, Bad Sooden-Allendorf (DE)

(73) Assignee: Hubner GmbH & Co. KG, Kassel (DE)

(21) Appl. No.: 14/419,345

(22) PCT Filed: Sep. 11, 2013
(86) PCT No.: PCT/DE2013/000513

§ 371 Date: Feb. 3, 2015

(30) Foreign Application Priority Data
Sep. 14, 2012 (DE) 20 2012 008 839.4

(51) Int. Cl. B64F 1/305

(52) U.S. Cl. CPC B64F 1/305

(57) ABSTRACT

The invention concerns an access tunnel to an aircraft (1), comprising a plurality of interconnected tunnel elements (3, 23).

The invention relates to an access tunnel to an aircraft.

An access tunnel of the afore-mentioned type for accessing an aircraft for example from a parked bus or from a building part is sufficiently known from the prior art. Such access tunnels are used when passengers must be allowed to access the aircraft from an exit of a building located at the level of the airfield without being subjected to climatic conditions.

As has already been mentioned, such access tunnels are known. At their ends, i.e. at their end facing the aircraft, they are often connected to passenger stairs, in order to allow passengers to access the aircraft.

The problem underlying the invention is protecting the path of the passengers, for example between the terminal building on the one hand and the passenger stairs on the other hand, against climatic conditions, wherein it is proposed according to the invention that the access tunnel has several tunnel elements, whereby the length of the access tunnel is adaptable in accordance with the respective situation. It is more specifically proposed that the access tunnel is adapted to be arranged on the terminal building so as to be movable relative to the building. This means that the tunnel element may be physically linked to the building, though linked in such a manner that it is more specifically pivotable relative to the building in order to be able to carry out the necessary orientation of the tunnel element from the building to the aircraft. It can be provided that the access tunnel is detachable from the building, for example in order to clear a street between the access tunnel and the building. The advantage here is that the passengers are protected from climatic conditions on their way from the terminal building to the access tunnel.

Advantageous features and embodiments of the invention can be gathered from the dependent claims.

Thus, it is more specifically provided that a bellows is provided between the tunnel element and the building. Thus, on the one hand, the bellows provides protection against climatic conditions in the gap between the building and the tunnel element and on the other hand the bellows is movable in such a manner that the access tunnel, respectively the individual tunnel element that is directly coupled to the building, is connected to the building by way of the bellows so that it is movable, more specifically pivotable, at will. The bellows does not necessarily have to be a folded or corrugated bellows. According to the invention, the term bellows also comprises any flexible weather protection device, i.e. for example also a tunnel shaped connection made of an elastic fabric covered with an elastomer.

Another embodiment is characterized in that the tunnel element is connected to the building by way of rotunda. Such a rotunda not only has a protective function; as an articulation element it also allows for an articulated connection between the building and the tunnel element. The invention also covers a combination of a rotunda and a bellows, wherein the bellows can form the connection between the rotunda and the building. This makes it possible to detach the bellows from the building and to push it together, for example in order to clear a street between the building and the tunnel element of an access tunnel.

According to another feature of the invention, it is provided that the tunnel element has a substantially rigid configuration in the longitudinal direction. A rigid configuration of a tunnel element is advantageous in that such an element is able to resist to high wind speeds.

The rigid tunnel element comprises several tunnel segments; by assembling individual segments, the length of the tunnel elements can be individually adapted. According to one variant, it is provided that the individual rigid tunnel elements are adapted to be pushed into one another, so that they may be stored in a space-saving manner if required. In this context it is expedient if the individual tunnel elements are displaceable. In order to be able to push the tunnel elements into one another, the tunnel elements have for example respectively different diameters.

The distance between the terminal building and the aircraft is often relatively long; a single tunnel element would not be enough to bridge the distance, which is why it is proposed that at least one other tunnel element is disposed as an extension on the one tunnel element serving as base element. Thus it is then possible to form units of any length.

According to another advantageous feature of the invention, the at least one other tunnel element is configured to be telescopic. However, as has already been explained, it can also be rigid. In this regard, the other telescopic tunnel element is configured in the manner of a scissors-type frame, wherein an outer skin made of a reinforcement coated with an elastomer is disposed on the scissors-type frame. This means that the tunnel element is telescopically retractable. To this end, a motor drive is more specifically provided. The telescopic design is more specifically expedient in that after boarding, the airfield must be cleared again by retracting the other tunnel element.

In addition, it has turned out to also be advantageous if the tunnel element serving as a base element and the at least one other tunnel element serving as a telescopic tunnel element are adapted to be pushed into one another other. This means that for example the base element for an access tunnel has a slightly greater circumference than the adjacent other second element, so that when pushed together these other tunnel elements can be received by the tunnel element designed as a base element in the manner of a garage. This does not protect only the outer skin of the other, e.g. telescopic tunnel element, which, as has already been explained, consists of a reinforcement coated with an elastomer material, similar to those known from truck tarps or from bellows of gangways between two articulately connected vehicles.

As a matter of principle however, the rigid tunnel element also has such an outer skin made of a reinforcement coated with an elastomer instead of prepreg plates supported by frames of the tunnel element.

In addition, as a base element, the tunnel element is advantageously pivotably connected to the other tunnel element. However, the pivotable connection of two rigid or of two telescopic tunnel elements of a possible plurality of such tunnel elements is also an object of the invention. This must be seen against the following background. In regional airports where such access tunnels are often used, customary air passenger bridges often cannot be used precisely because the exit from the terminal building is located at ground level. Therefore, it is necessary for the access tunnel to be horizontally mobile. There are often obstacles on the airfield, which need to be taken into account when guiding the access tunnel, i.e. around which the access tunnel needs to run. An even higher degree of mobility of such an access tunnel is achieved when the at least one other tunnel element has individual segments that are pivotable relative to each other, so that the tunnel element is not only fastened to the respectively adjacent tunnel element in a horizontally displaceable manner but so that the direction of such an access tunnel on the airfield is considerably facilitated due to the mobility of the tunnel elements relative to each other.

It has already been pointed out that several tunnel elements are connected so that they are more specifically also horizontally displaceable. In order to protect the passengers from climatic conditions in those transitional areas, a bellows is provided between the individual tunnel elements. Such a bellows is advantageous in that it can follow almost all the movements between two articulately connected parts. However it can also be used as a rotunda.

In such an access tunnel comprising a tunnel element as a base element, to which several other tunnel elements are connected, it is more specifically provided that preferably the external or last tunnel element has its own drive, for example an electric motor that drives at least one wheel with which the tunnel element stands on the floor. However, it is also conceivable to provide a tractor unit, wherein the tractor unit may be any type of autonomously running vehicles. Thus it is more specifically conceivable that the vehicle for moving the access tunnel is the same vehicle as the one that is also responsible for supplying power to the aircraft when the aircraft is in parking position.

More specifically when the tunnel element has a drive and the tunnel element must be moved toward the aircraft along with the other tunnel elements potentially connected to it, it is necessary for the tunnel element to be displaceable at an angle to the longitudinal axis of the tunnel element. This means that the drive of the tunnel element must not only allow for a forward movement but also for a lateral movement.

It has also been mentioned previously that a driving wheel is disposed on the tunnel element, namely on the last tunnel element of an access tunnel, the driving wheel being advantageously horizontally pivotable around a vertically oriented axis provided on the frame of the tunnel element.

A passenger guidance system for guiding passenger flows on the ramp of the airport with individual tunnel elements as previously described is also an object of the invention.

In the following, the invention is exemplarily explained in more detail based on the drawings.

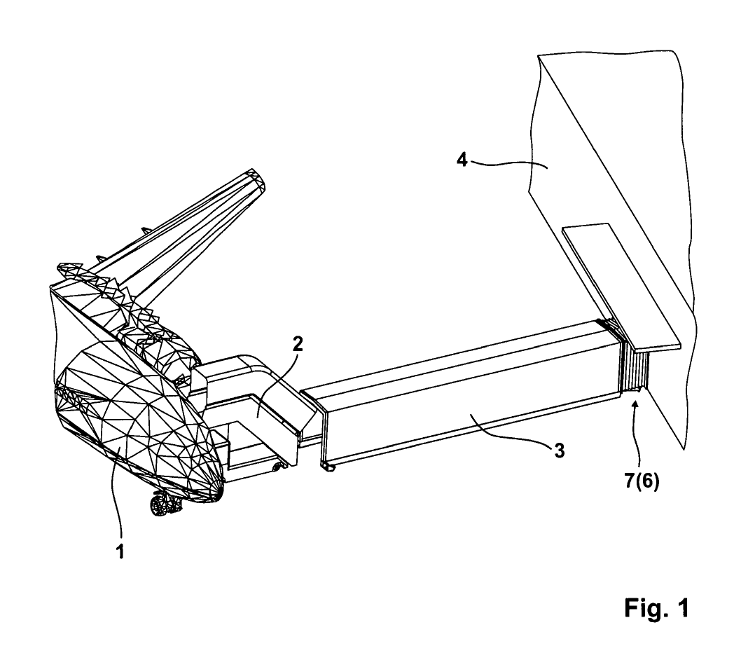

FIG. 1 schematically shows a rigidly configured tunnel element between a terminal building and passenger stairs;

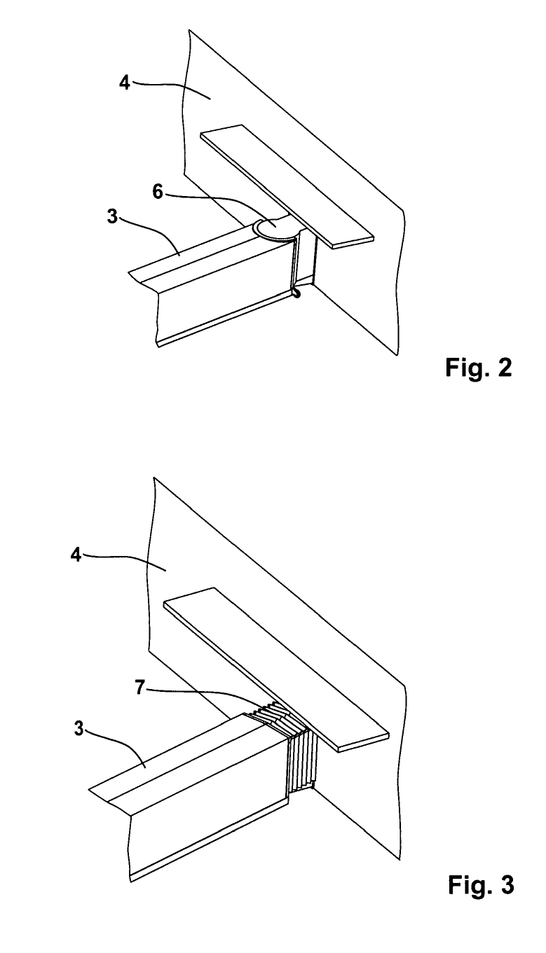

FIG. 2 shows a so-called rotunda serving as a connection between the tunnel element and the building;

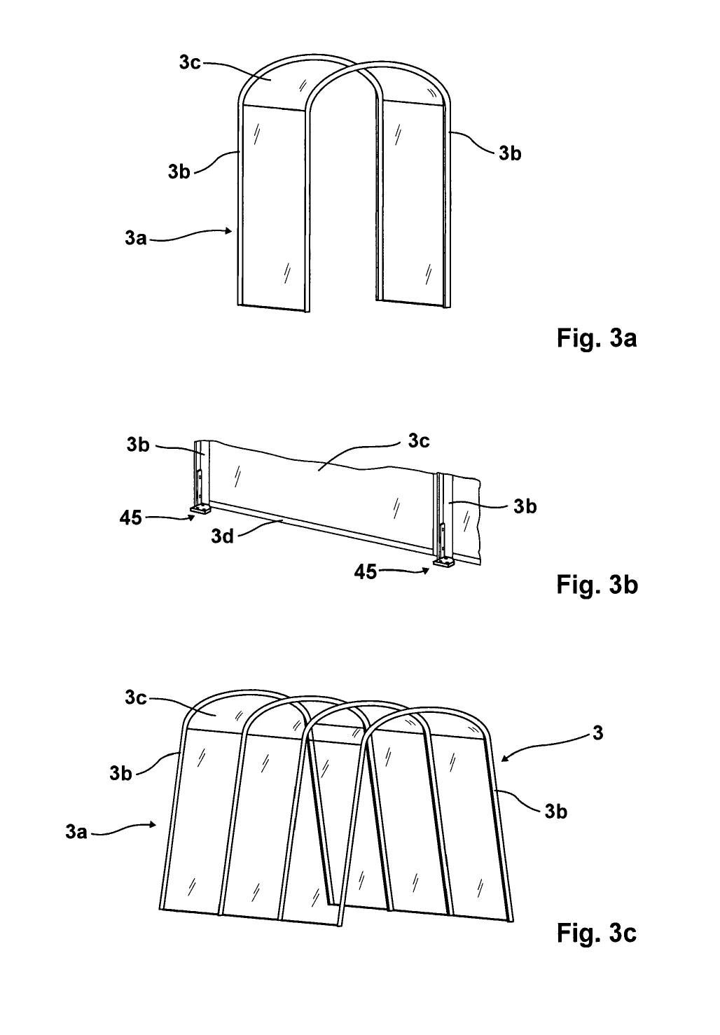

FIG. 3 shows a representation according to FIG. 2, wherein a bellows is used instead of the rotunda;

FIG. 3a shows a tunnel segment of a rigid tunnel element;

FIG. 3b shows a detail showing two tunnel segments forming a tunnel element;

FIG. 3c shows a tapered tunnel element;

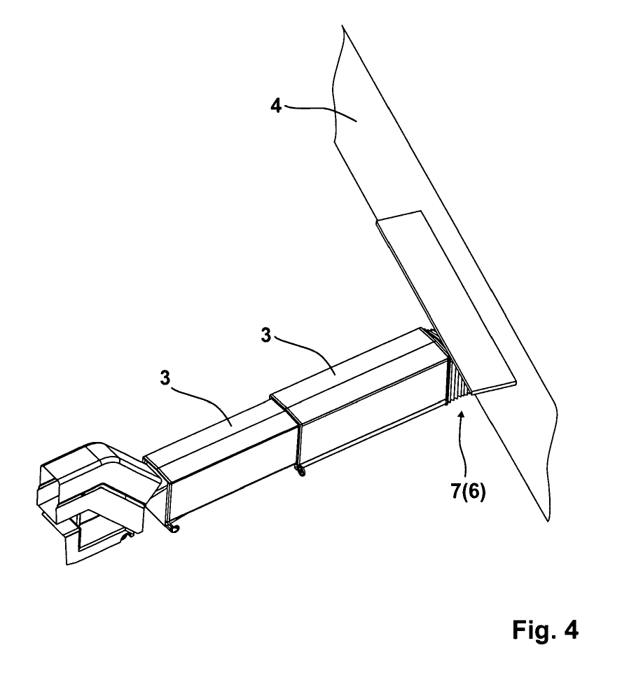

FIG. 4 shows an embodiment, wherein two tunnel elements are provided that are mounted so as to be slidable into each other;

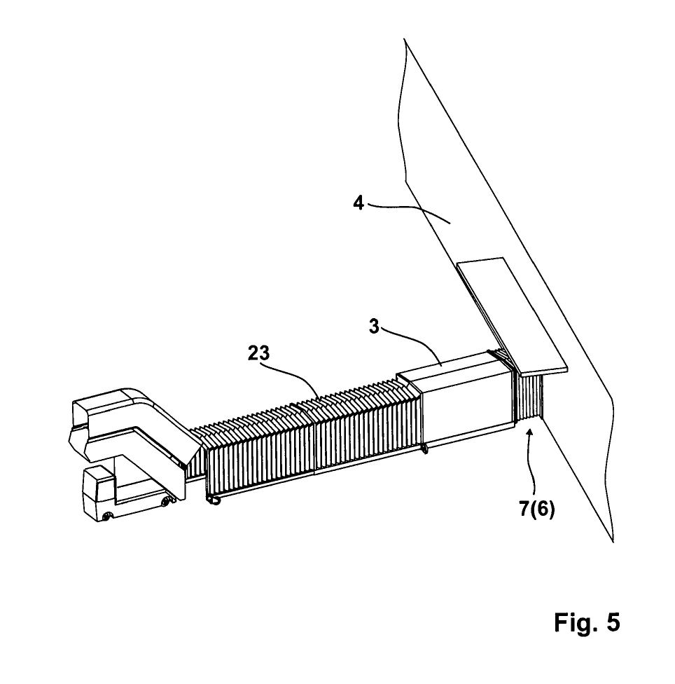

FIG. 5 shows an embodiment, in which a fixed tunnel element is connected to a tunnel element configured in the manner of a concertina.

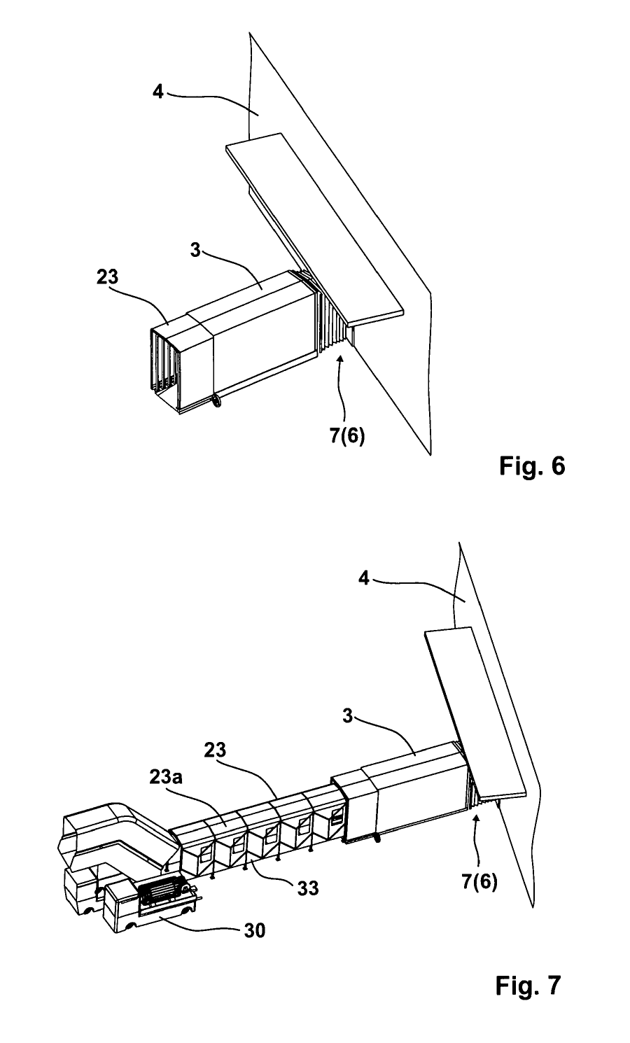

FIG. 6 shows an embodiment, in which the stationary tunnel element receives the tunnel element, which is foldable in the manner of a concertina, in the manner of a garage;

FIG. 7 schematically shows how the access tunnel is pulled toward the passenger bridge by a vehicle;

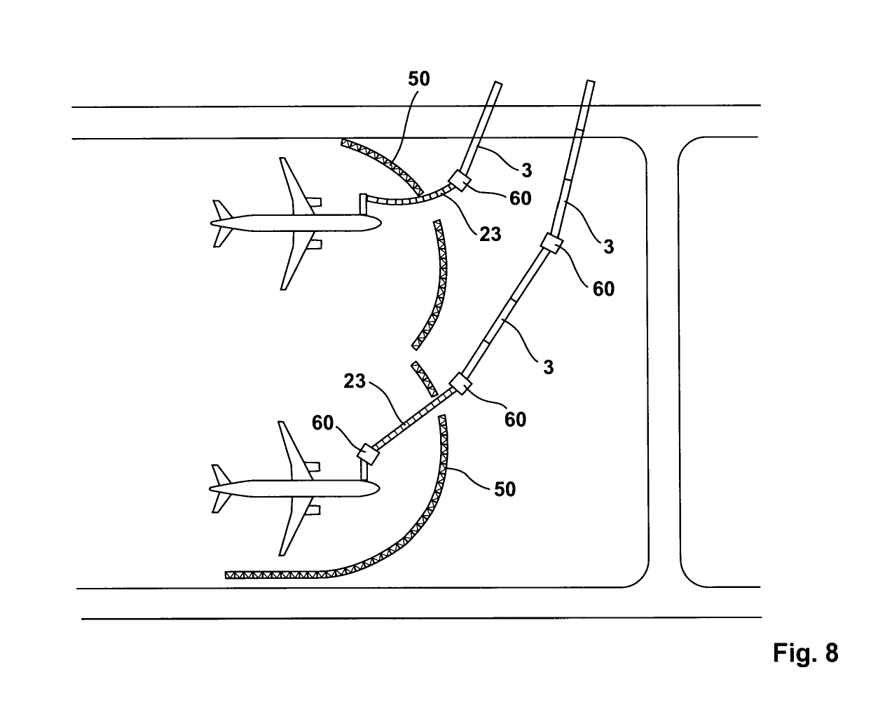

FIG. 8 schematically shows the airport ramp in front of a terminal building based on the example of a small regional airport.

In FIG. 1, one can see the schematic of the aircraft 1, the passenger stairs 2 and the tunnel element 3. At its end the tunnel element 3 is connected to the building 4, wherein the connection is not shown (see FIG. 2 and FIG. 3). The tunnel element 3 is configured as a rigid element, wherein such a tunnel element can be used when the distance between the aircraft on the one hand and the building on the other hand is substantially unchanging, which is the case when the aircraft are always parked in the same parking position and substantially always have approximately the same size.

FIG. 3a shows a rigid tunnel segment 3a of a rigid tunnel element 3, wherein several tunnel segments 3a form one tunnel element 3. Each tunnel segment has two parallel frames 3b, which receive a flexible or bent prepreg plate 3c. Instead of the prepreg plate, a tarp made of a reinforcement with a fabric coated with an elastomer can also be used.

The substantially rigid tunnel elements 3 can be fastened to the floor of the airport ramp by way of screw feet 45 by means of screws. The substantially rigid tunnel elements 6 additionally have sealing lips 3d (FIG. 3b) in their transition to the floor.

FIG. 3c shows a conically configured tunnel element 3, which makes it possible to transport such elements in a telescoped position.

In FIG. 2 and FIG. 3, one can see how the tunnel element 3 is connectable to the building 4, namely on the one hand by a rotunda 6 (FIG. 2) or according to FIG. 3 by a bellows 7.

In the representation according to FIG. 4, the first tunnel element 3 is connected to a second, also rigid tunnel element 13 in such a manner that the tunnel element 13 is slidably receivable by the tunnel element 3, i.e. the two tunnel elements 3 and 13 are connected in a telescopic manner. Both tunnel elements can be configured so as to be rigid in the longitudinal direction, which is particularly advantageous in case of strong winds.

In the representation according to FIG. 5, a rigid tunnel element 3 is connected to a flexible tunnel element 23, wherein the flexible tunnel element 23 has a length that is modifiable in the manner of a concertina or folded bellows. In this regard, FIG. 6 shows that this concertina-shaped tunnel element is received by the fixed tunnel element 3 in the manner of a garage. In order to provide inherent stability, the tunnel element configured in the manner of a folded bellows has telescopic rails 33 in the region of the ends of the legs, i.e. rails that are mounted in a telescopic manner.

In FIG. 7 one can see how a foldable tunnel element can be pulled by a vehicle 30 to the passengers stairs at the aircraft. In the present case, the vehicle is a vehicle having a generator for supplying the aircraft with power.

At their bottom end, the tunnel elements have rolls, since they must be movable on the airport ramp, as has already been repeatedly explained. When the tunnel elements are not moved into the desired position by a tractor or a similar vehicle as shown for example in FIG. 7, it can be provided that the individual tunnel elements have their own drive, for example an electromotor that is connected to one or several wheels. It is conceivable to design the wheels to be steerable, in order to be able to carry out a positioning of the tunnel elements in a plane. This means that the tunnel element, or rather the access tunnel is manipulable by means of a joy-stick.

FIG. 8 shows a schematic of the design of such an access tunnel to an aircraft. One or several stationary elements 3 are provided, wherein several tunnel elements 23 are disposed on the end of the last element 3, which are connected to each other so that they are pivotable around a vertical axis, respectively, if required, the individual tunnel elements are formed by segments that are also connectable to each other so that they are pivotable relative to each other around horizontal axes. Thus the tunnel can be shaped in any manner, as required, for example when the aircraft is separated from the area of the terminal building by a blast deflector 50, as shown in FIG. 8.

The individual tunnel sections are connected by bellows 60 or rotundas, in order to protect the passengers from climatic conditions inside the connection between the tunnel sections.

### LIST OF REFERENCE NUMBERS

1 aircraft
2 passenger stairs
3 tunnel element (rigid)
3a tunnel segment
3b frame
3c prepreg plate
3d sealing lips
4 building
6 rotunda
7 bellows
23 tunnel element
23a outer skin on a telescopic tunnel element
30 vehicle
33 telescopic rails
45 screw feet
50 blast deflector

1-26. (canceled)

27. An access tunnel for access to an aircraft disposed on a ramp of an airport, the access tunnel comprising:
a substantially rigid first tunnel element functioning as a base element; and
at least one concertina-shaped second tunnel element connected to the first tunnel element and functioning as an extension of the first tunnel element;
wherein the at least one concertina-shaped second tunnel element slides into the first tunnel element and the first tunnel element functions as a garage for the second tunnel element.

28. An access tunnel in accordance with claim 27, wherein the substantially rigid first tunnel element is connectable to the ground.

29. An access tunnel in accordance with claim 27, the substantially rigid first tunnel element has sealing lips in a ground contact area to prevent the infiltration of ground water.

30. An access tunnel in accordance with claim 27, wherein the substantially rigid first tunnel element comprises a plurality of substantially rigid first tunnel elements connected such that they are slidable into one another.

31. An access tunnel in accordance with claim 27, wherein the at least one second tunnel element is telescopic.

32. An access tunnel in accordance with claim 31, wherein the telescopic second tunnel element comprises a scissors-type frame and an outer skin disposed on the scissors-type frame, the outer skin being a reinforcement coated with an elastomer.

33. An access tunnel in accordance with claim 31, further comprising a motor for telescoping the at least one second tunnel element.

34. An access tunnel in accordance with claim 27, wherein the substantially rigid first tunnel element is pivotally connected to an additional rigid first tunnel element or to a telescopic second tunnel element.

35. An access tunnel in accordance with claim 27, wherein a bellows is disposed between the first and second tunnel elements.

36. An access tunnel in accordance with claim 27, further comprising a drive.

37. An access tunnel in accordance with claim 27, wherein the substantially rigid first tunnel element and the at least one second tunnel element each have a floor.

38. An access tunnel in accordance with claim 27, wherein the substantially rigid first tunnel element and the at least one second tunnel element are adapted to be docked onto passenger stairs.
